(19) United States
(12) Patent Application Publication
(10) Pub. No.: US 2006/0136444 A1
(43) Pub. Date: Jun. 22, 2006

(54) System and method for integrated information service

(75) Inventor: Cheng-Yung Chang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/015,050

(22) Filed: Dec. 17, 2004

(51) Int. Cl. G06F 17/00

(52) U.S. Cl. 707/101

(57) ABSTRACT

A system for integrated information service is provided. The system of integrated information service comprises an interface, a first storage device, a second storage device, and a processor. The interface receives query information for manufacturing information. The first storage device stores manufacturing information from a plurality of separate data sources corresponding to different stages of manufacture of semiconductor devices. The second storage device stores configuration data for information service pertaining to each of the data sources corresponding to different stages of manufacturing. The processor provides information service according to the query information, the configuration data, and the manufacturing information.

### BACKGROUND

The present invention relates to an information service system and particularly to an information service system integrating manufacturing information obtained from a plurality of separate data sources corresponding to different stages of wafer manufacture.

Manufacturing processes, such as semiconductor device manufacturing processes, commonly employ a series of processing steps. A semiconductor device goes hundreds or thousands of steps before reaching its final form. In order to provide easy access for a customer having ordered a product and give them greater ownership of the entire design and production process, the “virtual fab” concept has recently emerged. The virtual fab goes many steps beyond the FedEx concept of product tracking, allowing customers to know, on line and in real time, all pertinent information related to their wafer lots. Advanced versions of the virtual fab include the ability to tailor the virtual fab to integrate with the customer's management system such that data, normally available only from “captive machines” can be displayed and manipulated as if the tools of the virtual fab were actually at the customer's site.

The conventional virtual fab system enables customers to place their orders online, trace contract execution, make production schedule inquiries, acquire invoice and payment information, acquire various production reports, and download design documents online. The conventional virtual fab has improved online access to crucial information and a wider range of services. These various information services, however, involve different data sources corresponding to different stages of the manufacture of semiconductor devices, and are accomplished through separate service channels. FIG. 1 is a schematic view of a conventional information service system implemented in a semiconductor manufacturing system. Computer 11 connects to servers 15a, 15b, and 15c through network 13. Servers 15a, 15b, and 15c connect to databases 17a, 17b, and 17c, respectively. Databases 17a, 17b, and 17 c store manufacturing information from separate data sources corresponding to different stages of manufacture of semiconductor devices. Server 15a provides vital foundry information, stored in database 17a, in a variety of formats. Server 15b provides engineering information, stored in database 17b, in a variety of formats. Server 15 c provides process setting information, stored in database 17c, in a variety of formats. Additionally, the information service can be accomplished manually, by, for example, facsimiles and e-mail messages.

The conventional information service has several disadvantages.

First, the information provided by servers 15a, 15b, and 15 c is retrieved independently from database 17a, 17b, and 17c, respectively, therefore data inconsistency may occur.

Second, information provided by different servers may have different formats, and thus cause difficulty in integrating information obtained from different servers.

Third, information provided by different servers may have different service quality, thus increasing difficulty in service quality control. Additionally, a certain information service can be requested via different ways, thus the service flow is various and difficult to efficiently manage.

Hence, there is a need for an information service system that addresses the problems arising from the existing technology.

### SUMMARY

It is therefore an object of the invention to provide a system and method of integrated information service to improve the handling of manufacturing information pertaining to different stages in manufacturing processes.

To achieve this and other objects, the present invention provides a system and method of integrated information service.

According to the present invention, a system for integrated information service is implemented in a manufacturing system. The system of integrated information service comprises an interface, a first storage device, a second storage device, and a processor. The interface receives query information for manufacturing information. The first storage device stores manufacturing information from a plurality of separate data sources corresponding to different stages of manufacture of semiconductor devices. The second storage device stores configuration data for information service pertaining to each of the data sources corresponding to different stages of manufacturing. The processor provides information service according to the query information, the configuration data, and the manufacturing information.

The present invention also provides a method of integrated information service. First, manufacturing information is provided, wherein the manufacturing information is obtained from separate data sources corresponding to different stages of manufacturing. Second, configuration data for information service is defined, wherein the configuration data pertains to each of the data sources corresponding to different stages of manufacturing. When query information for manufacturing information is received, the information service as defined by the configuration data is provided according to the query information and the manufacturing information.

The above-mentioned method may take the form of program code embodied in a tangible media. When the program code is loaded into and executed by a machine, the machine becomes an apparatus for practicing the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional information service system;

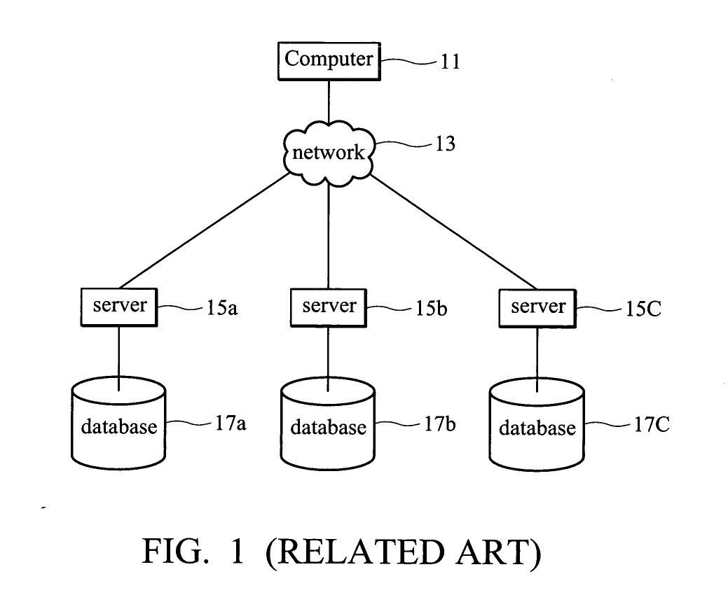

FIG. 2 is a schematic view of an information service system according to one embodiment of the present invention;

FIG. 3 is a flowchart of the information service method of the system in FIG. 2; and

FIG. 4 is a diagram of a storage medium storing a computer program providing the information service method.

### DETAILED DESCRIPTION

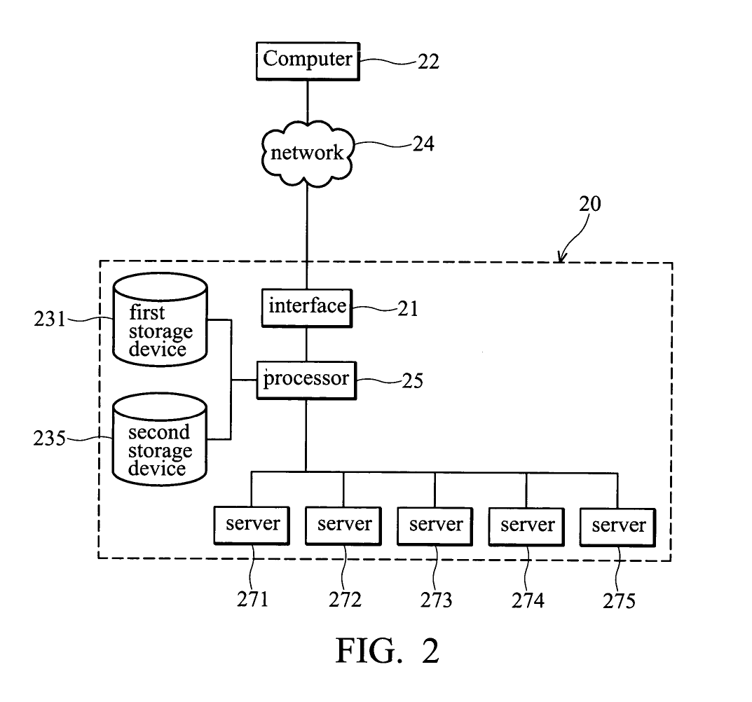

The present invention will now be described with reference to FIGS. 2 to 4, in general relating to an integrated information service implemented in a manufacturing system. While the preferred embodiment of the invention operates with semiconductor manufacturing systems, it is understood that the type of article processed by the manufacturing system is not critical to the present invention, and any manufacturing system utilizing multiple data centers to manipulate manufacturing information pertaining to different manufacturing stages may operate with the present invention.

FIG. 2 is a schematic view of an integrated information service system according to the present invention. The information service system 20 contains an interface 21, a first storage device 231, a second storage device 235, a processor 25, and servers 271˜275. The interface 21 communicates with a computer 22 via a network 24. The processor 25 connects to interface 21, first storage device 231, second storage device 235, and servers 271˜275. The first storage device 231 stores manufacturing information from separate data sources corresponding to different stages of manufacturing. The manufacturing information comprises foundry and engineering information and process setting for manufacturing. The second storage device 235 stores configuration data for information service pertaining to each of the data sources corresponding to different stages of manufacture of semiconductor device. Each of the servers 271˜275 respectively processes manufacturing information from a specific data source corresponding to a specific stage of manufacturing. The interface 21 receives query information for manufacturing information and transfers it to processor 25. The processor 25 receives the query information, retrieves corresponding configuration data from the second database 235, and transfers the query information to one of the servers 271˜275 according to the configuration data. The server receives the query information and retrieves corresponding manufacturing information from the first database 231. Then the server transfers the manufacturing information to processor 25. The processor 25 receives the manufacturing information and presents it to the interface 21 according to the configuration data. The interface 21 presents the manufacturing information to the computer 22 via network 24.

The processor 25 further generates a service report for information service management. The service report comprises a record of information service accomplished during a period of time.

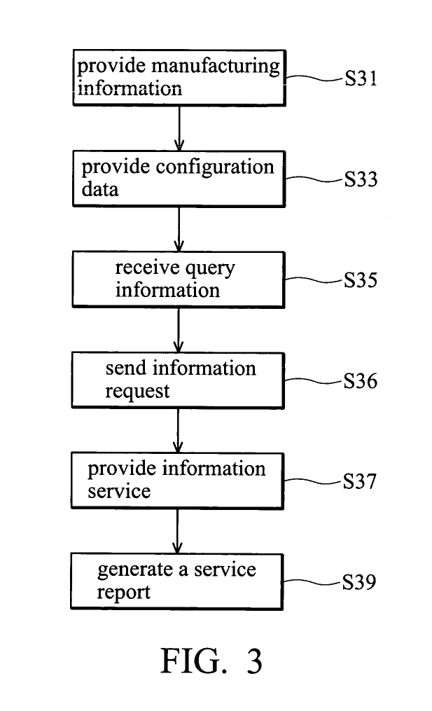

FIG. 3 is a flowchart of the information service method of the system described above.

First, manufacturing information is provided (step S31). The manufacturing information is obtained from a plurality of separate sources corresponding to different stages of manufacture of semiconductor devices. The manufacturing information comprises work-in-process (WIP) information, engineering information, and customized operation system for customer request. The WIP information comprises information for processing semiconductor devices, such as planning information for demand support, order processing, scheduled lot, in-process WIP, bank lot, FG, shipping, and invoice. The engineering information comprises engineering information for manufacture of semiconductor devices, such as information for mask, design, in-line process (ADI, AEI, Defect, M1/M2 WAT), wafer acceptance test (WAT), circuit probe (CP), BIN map, inkless, assembly yield, FT yield, and reliability. The customized operation system for customer request comprises process setting information for manufacture of semiconductor devices, such as special WAT gating rules and customer lot ID.

Second, configuration data for information service is provided (step S33). The configuration data specifies information service pertaining to each of the data sources corresponding to different stages of the manufacturing process. The configuration data can be modified to meet special needs.

Then query information for manufacturing information is received (step S35). The query information specifies content of inquiry information and corresponding information source.

Next, an information request is sent to a server specified in the configuration data (step S36).

Then information service as defined by the configuration data is provided according to the query information and the manufacturing information (step S37).

Moreover, a service report is generated according to a preset schedule (step S39). The service report may be generated by client, data source or under other account.

The method of the present invention, or certain aspects or portions thereof, may take the form of program code (i.e. instructions) embodied in a tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

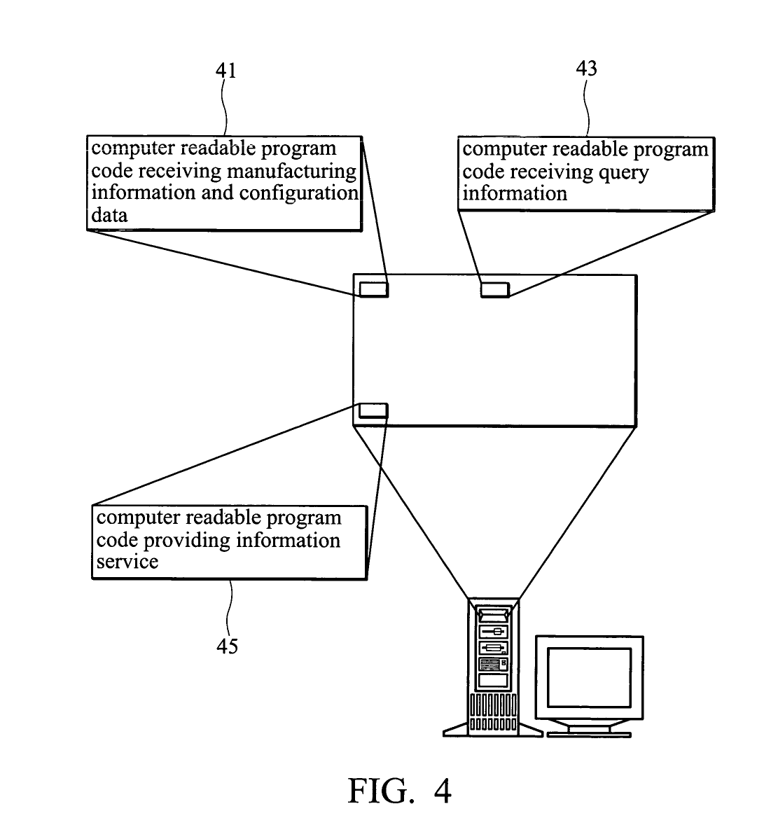

FIG. 4 is a diagram of a storage medium storing a computer program providing the information service method according to the present invention. The computer program product comprises a computer usable storage medium having computer readable program code embodied in the medium, the computer readable program code comprising computer readable program code 41 receiving manufacturing information and configuration data, computer readable program code 43 receiving query information for manufacturing information, and computer readable program code 45 providing information service as defined by the configuration data according to the query information and the manufacturing information.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art) . Therefore, the scope of the appended claims should be accorded the broadest interpretation so as to encompass all such modifications and similar arrangements.

What is claimed is:

1. A system for integrated information service, comprising:
an interface receiving query information for manufacturing information;
a first storage device storing manufacturing information from a plurality of separate sources corresponding to different stages of manufacturing;
a second storage device storing configuration data for information service pertaining to each of the sources corresponding to different stages of manufacturing; and
a processor providing information service according to the query information, the configuration data, and the manufacturing information.

2. The system of claim 1, wherein the processor further generates a service report comprising a record of information service.

3. The system of claim 1, wherein the processor further sends an information request to a server specified in the configuration data.

4. The system of claim 1, wherein the manufacturing information comprises foundry information for manufacturing.

5. The system of claim 1, wherein the manufacturing information comprises engineering information for manufacturing.

6. The system of claim 1, wherein the manufacturing information comprises process setting information for manufacturing.

7. A method for integrated information service, comprising:
providing manufacturing information, wherein the manufacturing information is obtained from a plurality of separate sources corresponding to different stages of manufacturing;
providing configuration data for information service pertaining to each of the sources corresponding to different stages of manufacturing;
receiving query information for manufacturing information; and
providing information service as defined by the configuration data according to the query information and the manufacturing information.

8. The method of claim 7, further generating a service report comprising a record of information service.

9. The method of claim 7, further sending an information request to a server specified in the configuration data.

10. The method of claim 7, wherein the manufacturing information comprises foundry information for manufacturing.

11. The method of claim 7, wherein the manufacturing information comprises engineering information for manufacturing.

12. The method of claim 7, wherein the manufacturing information comprises process setting information for manufacturing.

13. A computer readable storage medium for storing a computer program providing a method for integrated information service, the method comprising:
retrieving manufacturing information, wherein the manufacturing information is obtained from a plurality of separate sources corresponding to different stages of manufacturing;
retrieving configuration data for information service pertaining to each of the sources corresponding to different stages of manufacturing;
receiving query information for manufacturing information; and
providing information service as defined by the configuration data according to the query information and the manufacturing information.

14. The storage medium of claim 13, wherein the method further generates a service report comprising a record of information service.

15. The storage medium of claim 13, wherein the information service provision further sends an information request to a server specified in the configuration data.

16. The storage medium of claim 13, wherein the manufacturing information comprises foundry information for manufacturing.

17. The storage medium of claim 13, wherein the manufacturing information comprises engineering information for manufacturing.

18. The storage medium of claim 13, wherein the manufacturing information comprises process setting information for manufacturing.
